(19) United States
(12) Patent Application Publication
(10) Pub. No.: US 2004/0096782 A1
(43) Pub. Date: May 20, 2004

(54) Hermetic seal for diffractive elements

(76) Inventor: Gary R. Trott, San Mateo, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/295,556

(22) Filed: Nov. 14, 2002

(51) Int. Cl. G02B 27/42

(52) U.S. Cl. 430/321; 430/296; 359/558

(57) ABSTRACT

Multiple diffractive devices containing an environmentally delicate material such as photoresist are fabricated on a single substrate that is later cut to separate devices. One process shapes the material into multiple contoured regions on a single substrate. Each contoured region has the topography needed for a diffractive device and is separated from other contoured regions by saw streets. A seal layer, which may include an adhesion layer and a reflective layer is deposited over the contoured regions and extends into the saw streets. Cutting the substrate separates the diffractive devices with each diffractive device hermetically sealed between the seal layer and the substrate.

### BACKGROUND

Reflective diffractive elements generally have surfaces that are shaped so that reflected light forms a diffraction pattern that achieves a desired optical function. A reflection grating, for example, has lines spaced to create diffraction patterns from the incident light. A diffractive lens has a surface shaped to create a diffraction pattern that focuses a desired fraction of a particular frequency of light to a focal point. A general DOE (diffractive optical element) can be designed to create any optical pattern, including shapes such as rectangles or circles of even intensity, line profiles, spot arrays, illuminated images such as characters or numerals, and complex intensity profiles. The topography of the surface of the reflective diffractive element will generally depend on the optical function that the diffractive element performs and the frequency or frequencies of the light diffracted.

Grayscale photolithography is one method for creating the desired topography for the surface of a diffractive element. With grayscale photolithography, a layer of a photosensitive material such as photoresist is exposed to a light pattern in which the intensity of the light at each position on the photoresist layer determines an exposure depth in the photoresist at that position. A development process can then remove the exposed photoresist to leave the photoresist layer with a topography corresponding to the grayscale light pattern. The photoresist can then be covered with a reflective material to form the surfaces of a reflective diffractive element.

FIG. 1 shows a diffractive element 100 including a contoured photoresist layer 120 on a substrate 110. A reflective layer 130, typically made of a metal such as gold (Au), is deposited on photoresist layer 120 to provide the desired reflective surface.

Another function of reflective layer 130 is to protect photoresist layer 120 from the environment. Meeting the application environment and reliability standards for diffractive element 100 generally requires a hermetic seal or encapsulation to environmentally protect that photoresist layer 120. For example, to provide a hermetic seal, reflective layer 130 extends down the sides of photoresist layer 120 onto the sides of environmentally stable substrate 110. Accordingly, substrate 110 has the size required for diffractive element 100.

When manufacturing gratings, simultaneous fabrication of multiple gratings is desirable. However, handling and fixturing of a large number of small substrates for individual coatings can be slow and expensive. If multiple gratings were formed on one substrate, the gratings could be separated at the end of the manufacturing process. However, simply cutting substrate 110 of FIG. 1 in half would expose edges of photoresist layer 120, and the separate gratings would be subject to failure during environmental testing or during subsequent manufacturing assembly steps.

A further problem with cutting grating 100 is that the adhesion strength of thin film layers 120 and 130 may not be sufficient to withstand the separation process. Delamination may occur. Further, the adhesion properties of layers 120 and 130 are convolved together with their performance, and sufficient improvement in the adhesion strength may be difficult to achieve without degrading the product performance.

An alternative manufacturing process removes photoresist layer 120, for example, in an etching process that removes the photoresist layer and etches into underlying substrate 110 to transfer the surface topography to substrate 110. With no photoresist to protect, the requirement for a hermetic seal may change. However, such manufacturing processes are subject to variations and defects resulting from the need for very precise control of the etching process that removes the photoresist and shapes the substrate. Manufacturing processes that remove the photoresist thus may be unable to create diffractive elements having the same performance as diffractive elements such as diffractive element 100 that include contoured photoresist layers.

Hermetic seals and efficient manufacturing methods are thus needed for the manufacture of precision diffractive elements.

### SUMMARY

In accordance with an aspect of the invention, a method for manufacturing diffractive elements containing polymer material such as photoresist or another environmentally delicate material produces multiple diffractive elements on the same substrate and then separates the diffractive elements. The substrate containing the multiple diffractive elements has saw streets that allow separation of the diffractive elements without damaging the delicate material. To provide hermetic seals that remain intact, a seal layer for the delicate material extends into the saw streets and remains intact on a top surface of the substrate after a separation process such as sawing or scribing. The saw streets are wide enough that in each separated diffractive element the sealing material extends beyond the edge of the photoresist on the top surface of the underlying substrate and thereby hermetically seals the photoresist.

One specific embodiment of the invention is a process for fabricating diffractive devices. The process includes forming first and second contoured regions from a material such as a polymer on a surface of a substrate. On the substrate, a saw street that is free of the material separates the first contoured region from the second contoured region. The process deposits a seal layer that extends into the saw street on the substrate. The seal layer, which can include an adhesion layer of material such as chromium, titanium, tantalum, nickel, or nickel-chrome and a reflective layer of a metal such as gold, silver, aluminum, or dielectric reflectors generally covers the first and second contoured regions and serves to reflect light as required for the diffractive device. After forming the seal layer, cutting the substrate along the saw street separates individual diffractive devices. Each diffractive device thus includes a contoured region that is hermetically sealed between the seal layer and the substrate. The hermetic seal includes a portion of the seal layer that is on the top surface of the substrate.

Another specific embodiment of the invention is a device that includes a substrate, a contoured region, and a seal layer. The contoured region can be made of an environmentally delicate material such as photoresist and has the topography required of a diffractive optical element. Generally, the contoured region is hermetically sealed between the substrate and the seal layer. The seal layer overlies the contoured region and adheres to the top surface of the substrate where the substrate extends beyond the contoured region. In some configurations, the contoured region has a second edge that is aligned with an edge of the substrate, and the seal layer extends down the second edge of the contoured region and onto the edge of the substrate. The seal layer can be reflective and such that reflections from the seal layer implement the function of the diffractive optical element. In one configuration, the seal layer includes an adhesion layer of a material such as chromium, titanium, tantalum, nickel, or nickel-chrome that adheres to the substrate and a reflective layer of a reflective material such as gold, silver, aluminum, or a dielectric stack.

The device can further include a second contoured region having the topography required for another diffractive element. The first and second contoured regions with an intervening saw street are on the surface of the same substrate. hi this configuration, cutting the substrate along the saw street can create separate diffractive devices.

### BRIEF DESCRIPTION OF THE DRAWINGS

FIG. 1 is a cross-sectional view of a conventional diffractive element containing a contoured photoresist layer.

FIG. 2 is a flow diagram for a fabrication process in accordance with an embodiment of the invention.

FIGS. 3, 4, and 5 are cross-sectional views of structures formed during a manufacturing process in accordance with an embodiment of the invention that simultaneously forms multiple diffractive elements.

FIGS. 6 and 7 are cross-sectional views of diffractive elements after separation from the structure of FIG. 2.

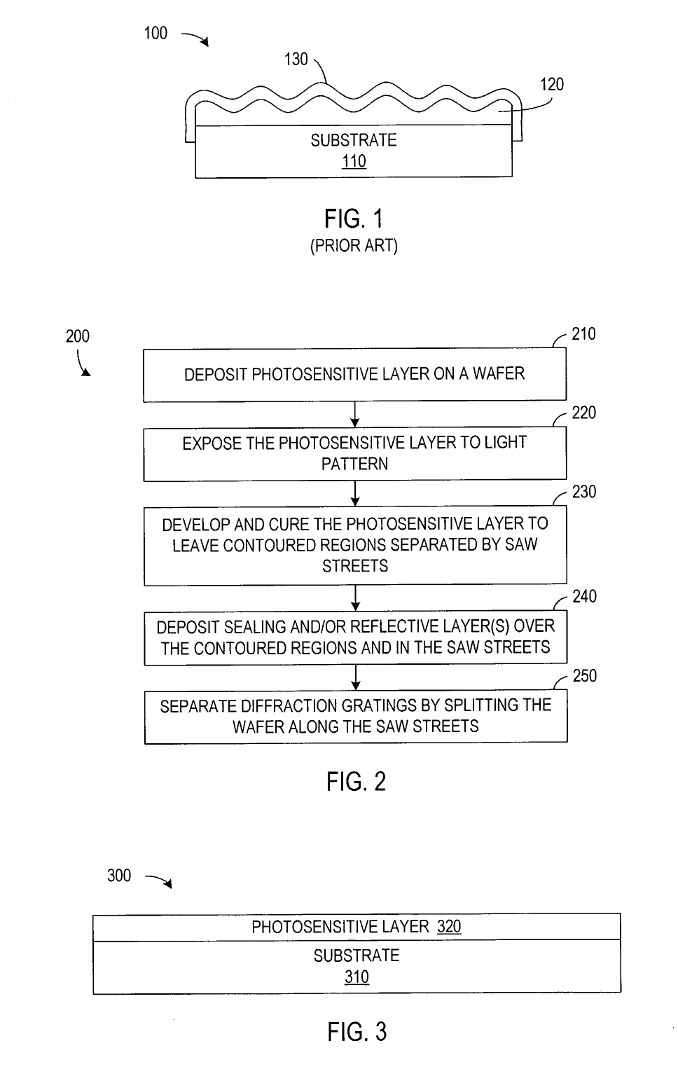

Use of the same reference symbols in different figures indicates similar or identical items.

### DETAILED DESCRIPTION

A manufacturing process for a diffractive element forms a combined structure containing multiple diffractive elements with saw streets separating the diffractive elements. A sealing layer that covers an environmentally delicate material in the diffractive elements extends into the saw streets of the combined structure. A separation process such as sawing or scribing then separates the diffractive elements for use, but leaves the sealing layer attached to remaining portions of the saw streets to maintain hermetic seals that protect the environmentally delicate material.

FIG. 2 is a flow diagram of a fabrication process 200 for diffractive elements in accordance with an embodiment of the invention. Process 200 includes fabrication steps 210, 220, 230, 240, and 250 that form structures such as illustrated in FIGS. 3, 4, 5, 6, and 7. Process steps 210, 220, 230, 240, and 250 of FIG. 2 are thus described with reference to exemplary structures illustrated in FIG. 3, 4, 5, 6, and 7.

Step 210 deposits a layer 320 of a material on a substrate 310 as illustrated in FIG. 3. Layer 320 can be of any material that is suitable for patterning that forms the topography of a diffractive optical element. In an exemplary embodiment of the invention, the material of layer 320 is a photosensitive material that can be pattern using known photolithographic techniques. Other examples of suitable materials for layer 320 are electron beam resists and materials that can be embossed, molded, or otherwise mechanically shaped using techniques such as ruling or ion milling.

Substrate 310 is generally made of a material having a low thermal coefficient of expansion to reduce the effects of temperature changes on the dimensions of the diffractive elements being manufactured. Such dimensional changes would change the diffraction pattern and the optical performance of the diffractive elements. A material such as an ultralow expansion (ULE) glass is well suited for substrate 310, but materials such as silicon, sapphire, or any other material having suitable structural, environmental, and thermal properties could also be used.

In the exemplary embodiment, layer 320 can be made of any commercially available photosensitive material, and typically is deposited to a thickness between about 1 micron to about 100 microns depending on the type of diffractive elements being made. Methods for depositing and using such photoresist layers are well known in integrated circuit manufacturing processes.

Step 220 of FIG. 2 exposes layer 320 as required to change the properties of a portion of layer 320 that will be removed. A variety of methods for such exposure are possible and the particular method employed is not critical to the present invention. U.S. Pat. No. 6,410,213 describes one known method for exposing a photosensitive material to form a desired surface profile.

One suitable exposure process when layer 320 is a layer of photoresist involves a photolithographic process that projects onto the surface of photosensitive layer 320 light of the proper wavelength to activate photosensitive material. Layer 320 can be exposed with an electron beam when an electron beam resist is used. Exposure parameters, material parameters, and development parameters all can be varied to achieve the desired topography. Alternatively, multiple exposures with different radiation patterns can expose layer 320 to the proper depth at each point. In particular, a separate process can expose regions of layer 320 that correspond to the saw streets described further below.

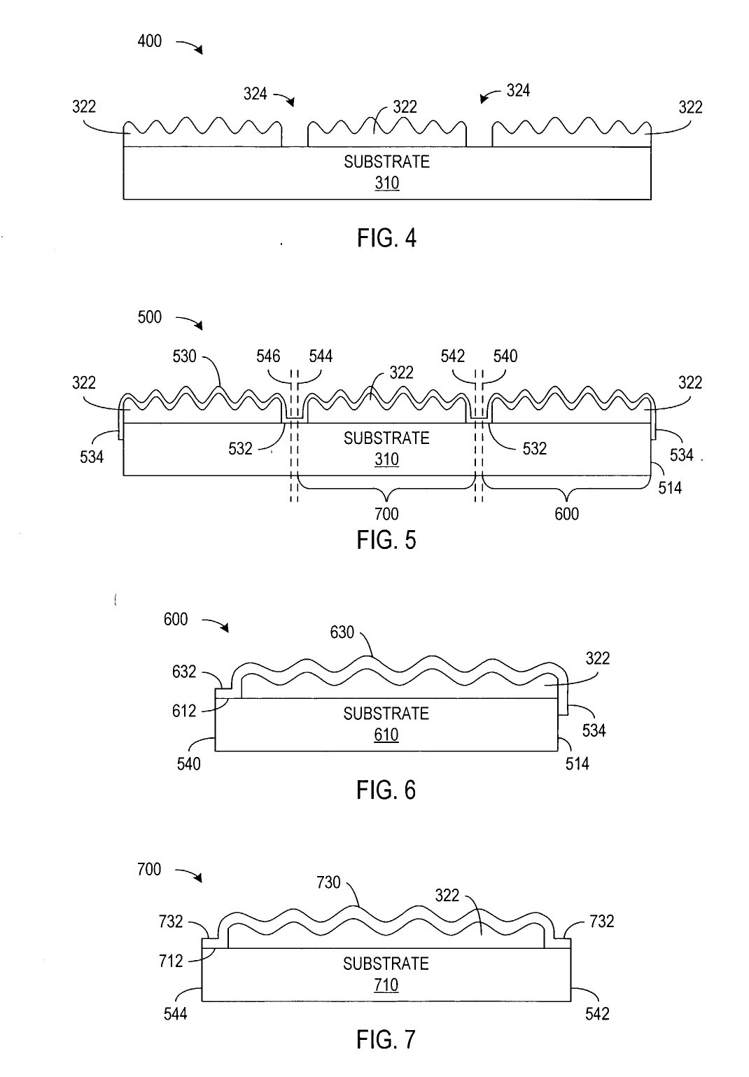

Step 230 is a development process that removes the irradiated portions of photosensitive layer 320 to leave regions 322 of unexposed material as shown in FIG. 4. As a result of the controlled exposure, each region 322 has a top surface contoured as required for a diffractive element. Optionally, the material in contoured regions 322 can then be cured or otherwise hardened to improve durability.

Mechanical processes can be used instead of the exposure and development (steps 220 and 230) to form contoured regions 322. One mechanical process, for example, stamps layer 320 to mechanically create the topology or pattern of regions 322. Alternatively, a mechanical process can cover substrate 310 with a mold and then inject the material of layer 320 into contoured cavities of the mold to form regions 322. In yet another alternative process, traditional grating ruling (scratching), ion milling, or other removal techniques can remove unwanted material from layer 320 to form regions 322.

Saw streets 324, which separate contoured regions 322, are areas of substrate 310 lacking the material of layer 320. Many techniques are known for creating structures such as saw streets 324. In the exemplary embodiment, the development process of step 230 removes portions of layer 320 between regions 322 to expose portions of substrate 310 and leave saw streets 324 between regions 322. Alternatively, a process separate from exposure and development steps 220 and 230 can remove portions of layer 320 to open saw streets 324. Laser ablation or a mechanical removal process, for example, could remove portions of layer 320 that are in saw streets 324. In yet another alternative process, the initial deposition of layer 320 may be controlled to avoid saw streets 324.

Saw streets 324 have a width that is selected according to the needs of the design, the separation method to be used to cut substrate 310, and the required size of a hermetic sealing area described below. In the exemplary embodiment of the invention, saw streets 324 are about 50 microns to 1000 microns wide to accommodate a 20-micron to 900-micron wide saw process positioned to a typical accuracy of about +/−25 microns.

Step 240 deposits a seal layer or layers 530 on regions 322 and in saw streets 324 as illustrated in FIG. 5. In the embodiment of FIG. 5, seal layer 530 extends across saw streets 324 and is cut when a separation process cuts substrate 310 into separate diffractive elements. Sawing and other separation processes are generally aggressive mechanical processes that can delaminate, tear, or peel back layers at their interfaces. However, since saw streets 324 are free of the material required for forming the topography of the diffractive element, seal layer 530 can be chosen to increase the adhesion to substrate 310.

Layer 530 will generally include a stack of layers. Layers of metals such as chromium (Cr), titanium (Ti), tantalum (Ta), nickel (Ni), nickel-chrome (NiCr) and others are known to enhance the adhesion of subsequent layers and can be deposited on substrate 310 particularly in saw streets 324. A top layer of a highly reflective and environmentally inert metal such as gold (Au) can complete layer 530. The top layer could alternatively include another metal or a dielectric reflector. In an exemplary embodiment of the invention, layer 530 includes 1500-Å layer of gold on a 500-Å layer of chromium. The combination of layers has suitable adhesion strength to substrate 310 and still provides the desired conformal, high reflectivity layer 530 needed for product performance.

In an alternative to structure 500 of FIG. 5, layer 530 can be patterned to expose portions of substrate 310 in the centers of saw streets 324. In particular, layer 530 can extend far enough into saw streets 324 to form hermetic seals for contoured regions 322 but still provide gaps in saw streets 324 that are wide enough for a cutting process that does not cut or damage layer 530.

After deposition of layer 530, step 250 separates individual diffractive elements. Many separation techniques such as sawing or scribing and breaking are known in the arena of integrated circuit manufacture and can be used to cut substrate 310 into individual grating pieces.

In an exemplary embodiment of FIG. 5, a sawing process removes the material of substrate 310 and layer 530 between parallel surfaces 540 and 542 and between parallel surfaces 544 and 546. Additional sawing along saw streets (not shown) that cross saw streets 324 may be necessary to separate individual diffractive elements. Sawing techniques and equipment that are well known in integrated circuit manufacture can cut substrate 310.

FIGS. 6 and 7 show cross-sectional views of diffractive elements 600 and 700 that result from the sawing of structure 500 of FIG. 5. Diffractive element 600 includes a substrate 610 and a reflective layer 630 that are portions cut respectively from edge portions of substrate 310 and layer 530 of FIG. 5. Between substrate 610 and reflective layer 630 is one of the regions 322 of environmentally delicate material. Diffractive element 600, which comes from an edge of substrate 310, inherits at least one edge 514 from substrate 310 and has at least one cut edge 540. Accordingly, diffractive element 600 has a hermetic seal 534 where layer 630 extends past the edge of region 322 onto the edge 514 of substrate 610. Near cut edge 540, a portion 632 of layer 630 attaches to the top surface 612 of substrate 610 to provide a hermetic seal for contoured region 322 at the cut edge 540. The size of the extension of substrate 610 beyond region 322 and the resulting hermetic seal at edge 540 depends on the width of saw streets 324 of FIG. 5, the width of the saw blade, and the accuracy of the cutting process.

Diffractive element 700 of FIG. 7 includes a substrate 710 and a reflective layer 730 respectively cut from the center of substrate 310 and layer 530. FIG. 7 shows two cut edges 542 and 544, and diffractive element 700 may only have cut edges. At each cut edge 542 and 544, a portion 732 of reflective layer 730 adheres to a top surface 712 of substrate 710 and forms a hermetic seal, where the top surface 712 extends beyond region 322.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is

1. A process for fabricating diffractive devices, comprising:
forming a first contoured region and a second contoured region from a material on a surface of a substrate, wherein a street that is free of the material separates the first contoured region from the second contoured region;
depositing a layer over the substrate, wherein the layer covers the first and second contoured regions and extends into the street between the contoured region; and
cutting the substrate along the street to form separate diffractive devices.

2. The process of claim 1, wherein each of the contoured regions has a topography required for a diffractive optical element.

3. The process of claim 1, wherein each of the separate diffractive devices includes one of the contoured regions that is hermetically sealed between a portion of the layer and a portion of the substrate.

4. The process of claim 1, wherein forming the contoured regions comprises:
depositing the material on the surface of the substrate;
irradiating the material in a pattern that activates the material to different depths at different points on the material; and
developing the material to remove the activated portions of the material and leave each of the contoured regions with a topography required for a diffractive optical element.

5. The process of claim 4, wherein the material comprises a photosensitive material.

6. The process of claim 4, wherein the material comprises an electron beam resist material.

7. The process of claim 1, wherein forming the first and second contoured regions comprises a mechanical process that forms contours on the contoured regions.

8. The process of claim 1, wherein depositing the layer comprises:
depositing a first layer that adheres to the substrate in the street between the first and second contoured regions; and
depositing a second layer that is reflective.

9. The process of claim 8, wherein the first layer comprises a material selected from the group consisting of chromium, titanium, tantalum, nickel, titanium nitride, and nickel-chrome.

10. The process of claim 8, wherein the second layer comprises a reflective metal.

11. The process of claim 8, wherein the second layer comprises a dielectric stack.

12. A device comprising:
a substrate;
a first contoured region on a surface of the substrate, the first contoured region having a topography required of a diffractive element, wherein the surface of the substrate extends beyond an edge of the first contoured region; and
a layer overlying the contoured region and adhering to the surface of the substrate where the substrate extends beyond the first contoured region.

13. The device of claim 12, wherein the first contoured region is a region of photoresist.

14. The device of claim 12, wherein the substrate comprises a low expansion glass.

15. The device of claim 12, wherein the layer is reflective and reflections from the layer implement a function of the diffractive element.

16. The device of claim 15, wherein the layer comprises:
a first layer that adheres to the substrate; and
a second layer of a reflective material.

17. The device of claim 16, wherein the second layer comprises a material selected from the group consisting of reflective metals and reflective dielectric stacks.

18. The device of claim 12, wherein the first contoured region is hermetically sealed between the substrate and the layer.

19. The device of claim 12, wherein the first contoured region has a second edge that is aligned with an edge of the substrate, and the layer extends down the second edge of the contoured region and onto the edge of the substrate.

20. The device of claim 12, further comprising a second contoured region that is on the surface of the substrate and has the topography required of another diffractive optical element, wherein the surface of the substrate includes a saw street that is between the first contoured region and the second contoured region.
